(19) United States
(12) Patent Application Publication
(10) Pub. No.: US 2026/0197157 A1
(43) Pub. Date: Jul. 9, 2026

(54) COMPUTING SYSTEM AND OPERATION METHOD THEREOF

(71) Applicant: GIGA-BYTE TECHNOLOGY CO.,LTD., New Taipei City (TW)

(72) Inventors: Quang Tuyen Le, New Taipei City (TW); Tse-Hsien Liao, New Taipei City (TW); Che Hao Liu, New Taipei City (TW); Wei-Hao Huang, New Taipei City (TW); Tai-Yi Lin, New Taipei City (TW)

(73) Assignee: GIGA-BYTE TECHNOLOGY CO.,LTD., New Taipei City (TW)

(21) Appl. No.: 19/302,092

(22) Filed: Aug. 18, 2025

Related U.S. Application Data
(60) Provisional application No. 63/741,417, filed on Jan. 3, 2025.

(30) Foreign Application Priority Data
Apr. 22, 2025 (TW) 114115066

(51) Int. Cl. H04L 9/08; H04L 9/32

(52) U.S. Cl. CPC H04L 9/0825; H04L 9/085; H04L 9/3247

(57) ABSTRACT

A computing system and an operation method thereof are provided. The computing system includes a master computer device and a slave computer device. The slave computer device is connected to a dedicated internet protocol address of the master computer device. The master computer device and the slave computer device respectively create a user account for password-free connection authentication. The slave computer device creates key data, and the slave computer device provides a public key of the key data to the master computer device, so that the master computer device confirms whether the slave computer device logs into the master computer device without a password according to the public key of the slave computer device. After the slave computer device logs into the master computer device without the password, the master computer device and the slave computer device perform distributed computing to train a large model.

### CROSS-REFERENCE TO RELATED APPLICATION

This application claims the priority benefit of U.S. Provisional Application No. 63/741,417, filed on Jan. 3, 2025 and Taiwan Application No. 114115066, filed on Apr. 22, 2025. The entirety of each of the above-mentioned patent applications is hereby incorporated by reference herein and made a part of this specification.

### BACKGROUND

### Technical Field

The disclosure relates to a system, and more particularly to a computing system and an operation method thereof.

### Description of Related Art

Generally, distributed computing between multiple computer apparatuses needs to establish connections between the computer apparatuses through manual setting by users, and start data transmission by manually logging in, so a lot of time and cost needs to be spent. Furthermore, generally, connection settings between the computer apparatuses also lack security, which is not conducive to performing distributed computing.

### SUMMARY

The disclosure provides a computing system and an operation method thereof, which may automatically establish a connection.

A computing system of the disclosure includes a master computer device and a slave computer device. The slave computer device is connected to a dedicated internet protocol address of the master computer device. The master computer device and the slave computer device respectively create a user account for password-free connection authentication. The slave computer device creates key data, and the slave computer device provides a public key of the key data to the master computer device, so that the master computer device confirms whether the slave computer device may log into the master computer device without a password according to the public key of the slave computer device. After the slave computer device logs into the master computer device without the password, the master computer device and the slave computer device perform distributed computing to train a large model.

An operation method of the disclosure is applicable to a computing system. The computing system includes a master computer device and a slave computer device. The operation method includes the following steps. A dedicated internet protocol address of the master computer device is connected through the slave computer device. A user account for password-free connection authentication is respectively created on the master computer device and the slave computer device. Key data is created through the slave computer device, and a public key of the key data is provided to the master computer device. Whether the slave computer device logs into the master computer device without a password is confirmed according to the public key of the slave computer device through the master computer device. After the slave computer device logs into the master computer device without the password, distributed computing is performed through the master computer device and the slave computer device to train a large model.

Based on the above, in the computing system and the operation method thereof of the disclosure, the slave computer device may be connected to the master computer device in the password-free login manner to perform distributed computing.

In order for the features and advantages of the disclosure to be more comprehensible, the following specific embodiments are described in detail in conjunction with the drawings.

### BRIEF DESCRIPTION OF THE DRAWINGS

FIG. 1 is a schematic diagram of a computing system according to an embodiment of the disclosure.

FIG. 2 is a flowchart of an operation method according to an embodiment of the disclosure.

FIG. 3 is a flowchart of performing identity authentication according to an embodiment of the disclosure.

FIG. 4 is a flowchart of a data transmission operation according to an embodiment of the disclosure.

### DESCRIPTION OF THE EMBODIMENTS

In order for the content of the disclosure to be easier to understand, the following embodiments are given as examples according to which the disclosure can indeed be implemented. In addition, wherever possible, elements/components/steps using the same reference numerals in the drawings and the embodiments represent the same or similar parts.

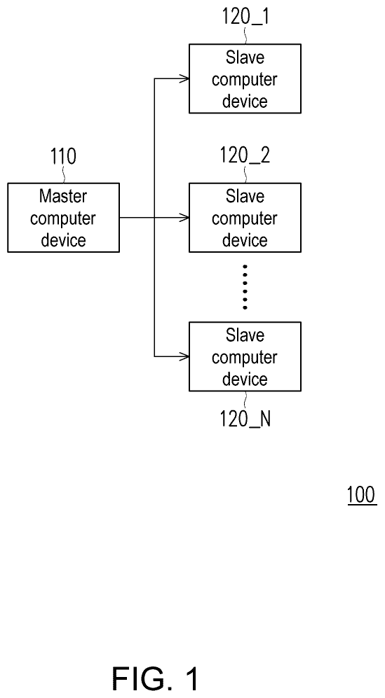

FIG. 1 is a schematic diagram of a computing system according to an embodiment of the disclosure. Referring to FIG. 1, a computing system 100 includes a master computer device 110 and multiple slave computer devices 120_1 to 120_N, where N is a positive integer. In an embodiment, the number of the slave computer devices 120_1 to 120_N may also be one. In the embodiment, each of the slave computer devices 120_1 to 120_N may be connected to the master computer device 110 through a Thunderbolt cable. Each of the slave computer devices 120_1 to 120_N may log into the master computer device 110 without a password.

In the embodiment, the master computer device 110 and the slave computer devices 120_1 to 120_N may respectively include a processor and a storage device. The processor may include, for example, a central processing unit (CPU), other programmable general-purpose or specific-purpose microprocessors, digital signal processors (DSP), programmable controllers, application specific integrated circuits (ASIC), programmable logic devices (PLD), other similar processing devices, or a combination of the devices. The storage device may include, for example, a dynamic random access memory (DRAM), a flash memory, a non-volatile random access memory (NVRAM), etc. In the embodiment, the storage device may be used to store algorithms, communication protocols, and application programs related to automatic connection methods, steps, and distributed computing described in various embodiments of the disclosure. In addition, the master computer device 110 and the slave computer devices 120_1 to 120_N may respectively further include a communication interface, an input device, and other peripheral functional elements, wherein the communication interface is used to implement connections between devices described in various embodiments of the disclosure.

In the embodiment, the master computer device 110 and the slave computer devices 120_1 to 120_N may respectively further include one or more video RAM (VRAM), dynamic random access memories (DRAM), and/or non-volatile memory express solid state drives (NVMe SSD). In the embodiment, the master computer device 110 may split a large model to perform distributed training or related cluster operations on a model 220. The computing system 100 may split the large model into multiple sub-models to be distributed to the video RAM, the dynamic random access memories, and/or the non-volatile memory express solid state drives of the master computer device 110 and the slave computer devices 120_1 to 120_N to selectively use computing resources of the master computer device 110 and the slave computer devices 120_1 to 120_N to effectively distribute the training of the large model. In the embodiment, the large model may be, for example, a large language model (LLM) or a large multimodal model (LMM).

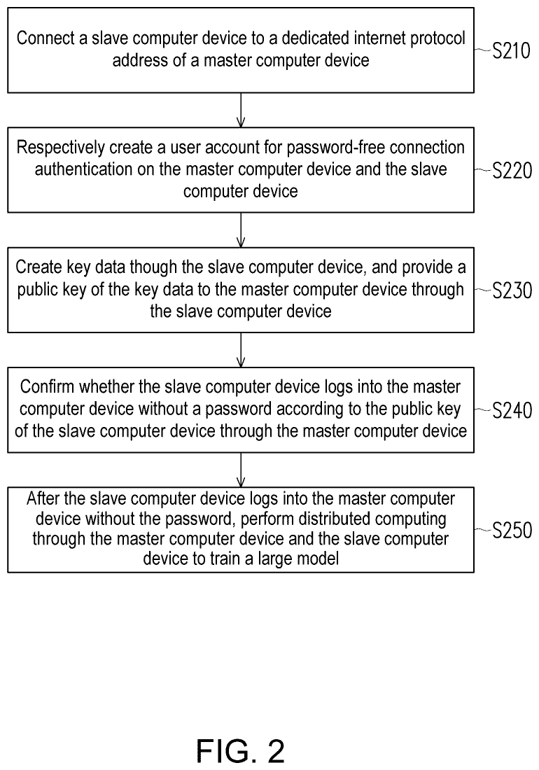

FIG. 2 is a flowchart of an operation method according to an embodiment of the disclosure. Referring to FIG. 1 and FIG. 2, taking a connection operation between the master computer device 110 and the slave computer device 120_1 as an example, the computing system 100 may perform steps S210 to S250 below. In the embodiment, a user may connect to the master computer device 110 and the slave computer device 120_1 via internet connection through a terminal computer device, and may assign dedicated internet protocol (IP) addresses to the master computer device 110 and the slave computer device 120_1. In step S210, the slave computer device 120_1 may be connected to the dedicated internet protocol address of the master computer device 110. In step S220, the user may respectively create a user account for password-free connection authentication on the master computer device 110 and the slave computer device 120_1. In step S230, the slave computer device 120_1 may create key data, and the slave computer device 120_1 provides a public key of the key data to the master computer device 110. In step S240, the master computer device 110 may confirm whether the slave computer device 120_1 logs into the master computer device 110 without a password according to the public key of the slave computer device 120_1. In step S250, after the slave computer device 120_1 logs into the master computer device 110 without the password, the master computer device 110 and the slave computer device 120_1 may perform distributed computing to train a large model.

In the embodiment, the master computer device 110 and the slave computer devices 120_1 to 120_N may be connected to each other without a password based on a secure shell protocol (SSH), but the disclosure is not limited thereto. Therefore, the computing system 100 of the embodiment may automatically and quickly establish a secure communication connection between the master computer device 110 and the slave computer device 120_1 to facilitate a data transmission operation during the distributed computing process. In addition, the slave computer devices 120_2 to 120_N may also perform the operation method of the above process to establish a connection relationship with the master computer device 110 for password-free login.

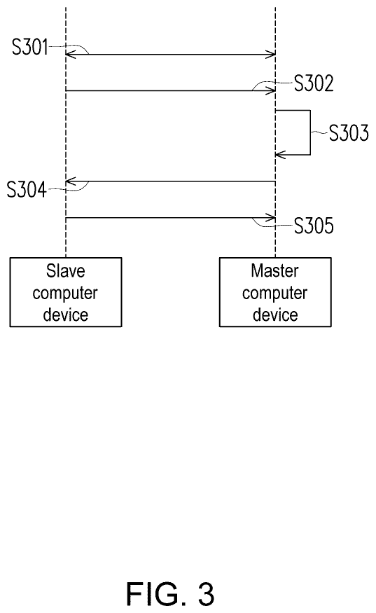

FIG. 3 is a flowchart of performing identity authentication according to an embodiment of the disclosure. Referring to FIG. 1 and FIG. 3, taking the connection operation between the master computer device 110 and the slave computer device 120_1 as an example, the computing system 100 may perform identity authentication as in steps S301 to S305 below. In step S301, the master computer device 110 and the slave computer device 120_1 may perform key exchange, and a session identifier (ID) is determined. In step S302, the slave computer device 120_1 may sign the session identifier, and send an identity authentication request to the master computer device 110. In step S303, the master computer device 110 may authenticate whether the session identifier is correct according to the identity authentication request. In step S304, when the session identifier is correct, the master computer device 110 may notify the slave computer device 120_1 that identity authentication is successful. In step S305, the slave computer device 120_1 may provide the public key and/or authentication data to the master computer device 110 to complete establishment of a communication channel. It is worth noting that when the master computer device 110 and the slave computer device 120_1 perform identity authentication to establish a connection for the first time, the session identifier generated above may be saved. In this regard, even if the computer device 110 and the slave computer device 120_1 re-exchange keys during a subsequent communication process, the same session identifier is still maintained between the master computer device 110 and the slave computer device 120_1. In addition, the slave computer devices 120_2 to 120_N may also perform identity authentication of the above process with the master computer device 110.

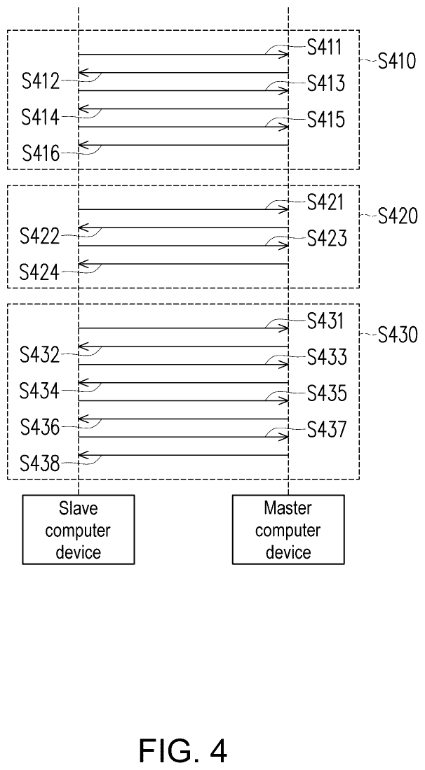

FIG. 4 is a flowchart of a data transmission operation according to an embodiment of the disclosure. Referring to FIG. 1 and FIG. 4, the specific implementation details of the process of steps S301 to S304 above may be further implemented by steps S410 to S438 of FIG. 4. In step S410, the master computer device 110 and the slave computer device 120_1 may perform the key exchange. In step S411, the slave computer device 120_1 may send an initialization key exchange request. The slave computer device 120_1 may send a communication command (taking the secure shell protocol as an example, for example, “SSH_MSG_KEXINIT”) to the master computer device 110. In step S412, the master computer device 110 may correspondingly respond with a corresponding communication command (for example, “SSH_MSG_KEXINIT”) to the slave computer device 120_1.

In the embodiment, the master computer device 110 and the slave computer device 120_1 may each generate a temporary session key pair. In step S413, the slave computer device 120_1 may provide the public key of the slave computer device 120_1 to the master computer device 110 (for example, through a communication command of “SSH_MSG_KEXDH_INIT”). In the embodiment, the slave computer device 120_1 may perform identity authentication of the master computer device 110 according to a host public key of the master computer device 110. The slave computer device 120_1 may obtain shared secret data according to the host public key, and obtain hash data according to a hash signature. The slave computer device 120_1 may generate a symmetric key for a data channel between the master computer device 110 and the slave computer device 120_1 and the session identifier according to the shared secret data and the hash data. In step S414, the master computer device 110 may return the public key of the slave computer device 120_1, the host public key of the master computer device 110, and the hash signature to the slave computer device 120_1 (for example, through a communication command of “SSH_MSG_KEXDH_REPLY”).

In step S415, the slave computer device 120_1 may notify the master computer device 110 that the key exchange is completed and a new session key is generated and is ready for subsequent encrypted communication (for example, through a communication command of “SSH_MSG_NEWKEYS”). In step S415, the master computer device 110 may also respond to the slave computer device 120_1 (for example, through a communication command of “SSH_MSG_NEWKEYS”), and subsequent encrypted communication may be performed.

In step S420, the computer device 120_1 may perform identity authentication. In step S421, the slave computer device 120_1 may send an authentication request to the master computer device 110 (for example, through a communication command of “SSH_MSG_SERVICE_REQUEST”). In step S422, the master computer device 110 may respond to the slave computer device 120_1 that the authentication request is accepted (for example, through a communication command of “SSH_MSG_SERVICE_ACCEPT”). In step S423, the slave computer device 120_1 may sign the session identifier according to the private key, and send the identity authentication request to the master computer device 110 (for example, through a communication command of “SSH_MSG_USERAUTH_REQUEST”).

In the embodiment, the slave computer device 120_1 copies the public key of the key data to an authorized public key list of the master computer device 110 in advance, so that the master computer device 110 determines whether to allow identity authentication according to the authorized public key list. When the master computer device 110 allows identity authentication, the master computer device 110 may authenticate whether the session identifier is correct according to the public key of the slave computer device 120_1 to establish the data channel for use during the process of training the large model. In step S424, the master computer device 110 may notify the slave computer device 120_1 that the identity authentication is successful (for example, through a communication command of “SSH_MSG_USERAUTH_SUCCESS”).

In step S430, the slave computer device 120_1 may perform remote operation (login) and command execution. In step S431, the slave computer device 120_1 may request a remote session service from the master computer device 110 (for example, through a communication command of “SSH_MSG_SERVICE_REQUEST”). In step S432, the master computer device 110 may respond to the slave computer device 120_1 with an approval request (for example, through a communication command of “SSH_MSG_SERVICE_ACCEPT”). In step S433, the slave computer device 120_1 may request a remote session service from the master computer device 110 (for example, through a communication command of “SSH_MSG_CHANNEL_OPEN”). In step S434, the master computer device 110 may confirm the identity of the slave computer device 120_1, and respond to the slave computer device 120_1 with a channel open confirmation (for example, through a communication command of “SSH_MSG_CHANNEL_OPEN_CONFIRMATION”).

In step S435, the slave computer device 120_1 may specify a request type to the master computer device 110 (for example, through a communication command of “SSH_MSG_CHANNEL_REQUEST”). In step S436, the master computer device 110 may respond to the slave computer device 120_1 that setting is successful (for example, through a communication command of “SSH_MSG_CHANNEL_SUCCESS”). In step S437, the slave computer device 120_1 may send data to the master computer device 110 to request a remote session service (for example, through a communication command of “SSH_MSG_CHANNEL_DATA”). In step S438, when data transmission is completed, the master computer device 110 may notify the slave computer device 120_1 to close the channel (for example, through a communication command of “SSH_MSG_CHANNEL_CLOSE”).

Therefore, the computing system 100 of the embodiment may automatically and quickly establish the secure communication connection between the master computer device 110 and the slave computer device 120_1 to implement, for example, the SSH password-free login and the data transmission operation. In addition, the slave computer devices 120_2 to 120_N may also perform the above process with the master computer device 110, so that the master computer device 110 may establish connection with multiple slave computer devices and may easily distribute computing data required for training of the large model.

In summary, in the computing system and the operation method thereof of the disclosure the secure communication connection may be quickly established between the master computer device and the slave computer devices, and the slave computer device may be connected to the master computer device in the password-free login manner, so that the computing system may perform distributed computing through the memory computing resources of the master computer device and the slave computer devices.

Although the disclosure is disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A computing system, comprising:
a master computer device; and
a slave computer device, connected to a dedicated internet protocol address of the master computer device,
wherein the master computer device and the slave computer device respectively create a user account for password-free connection authentication,
wherein the slave computer device creates key data, and the slave computer device provides a public key of the key data to the master computer device, so that the master computer device confirms whether the slave computer device logs into the master computer device without a password according to the public key of the slave computer device,
wherein after the slave computer device logs into the master computer device without the password, the master computer device and the slave computer device perform distributed computing to train a large model.

2. The computing system according to claim 1, wherein the master computer device and the slave computer device perform key exchange, and determine a session identifier,
wherein the slave computer device signs the session identifier, and sends an identity authentication request to the master computer device,
wherein the master computer device authenticates whether the session identifier is correct according to the identity authentication request,
wherein when the session identifier is correct, the master computer device notifies the slave computer device that identity authentication is successful.

3. The computing system according to claim 2, wherein the master computer device and the slave computer device each generate a temporary session key pair, and the slave computer device provides the public key of the slave computer device to the master computer device, so that the master computer device returns the public key of the slave computer device, a host public key of the master computer device, and a hash signature to the slave computer device.

4. The computing system according to claim 3, wherein the slave computer device performs identity authentication of the master computer device according to the host public key of the master computer device,
wherein the slave computer device obtains shared secret data according to the host public key, and obtains hash data according to the hash signature, wherein the slave computer device generates a symmetric key for a data channel between the master computer device and the slave computer device and the session identifier according to the shared secret data and the hash data.

5. The computing system according to claim 4, wherein the slave computer device signs the session identifier according to a private key.

6. The computing system according to claim 4, wherein the slave computer device copies the public key of the key data to an authorized public key list of the master computer device in advance, so that the master computer device determines whether to allow identity authentication according to the authorized public key list.

7. The computing system according to claim 6, wherein the master computer device authenticates whether the session identifier is correct according to the public key of the slave computer device to establish the data channel for use during a process of training the large model.

8. The computing system according to claim 1, wherein the slave computer device is connected to the master computer device through a Thunderbolt cable.

9. An operation method of a computing system, wherein the computing system comprises a master computer device and a slave computer device, the operation method comprising:
connecting to a dedicated internet protocol address of the master computer device through the slave computer device;
respectively creating a user account for password-free connection authentication on the master computer device and the slave computer device;
creating key data through the slave computer device, and providing a public key of the key data to the master computer device;
confirming whether the slave computer device logs into the master computer device without a password according to the public key of the slave computer device through the master computer device; and
after the slave computer device logs into the master computer device without the password, performing distributed computing through the master computer device and the slave computer device to train a large model.

10. The operation method according to claim 9, wherein the step of confirming whether the slave computer device logs into the master computer device without the password comprises:
performing key exchange through the master computer device and the slave computer device, and determining a session identifier;
signing the session identifier through the slave computer device, and sending an identity authentication request to the master computer device;
authenticating whether the session identifier is correct according to the identity authentication request through the master computer device; and
when the session identifier is correct, notifying the slave computer device that identity authentication is successful through the master computer device.

11. The operation method according to claim 10, wherein the step of performing the key exchange comprises:
generating a temporary session key pair through each of the master computer device and the slave computer device; and
providing the public key of the slave computer device to the master computer device through the slave computer device, so that the master computer device returns the public key of the slave computer device, a host public key of the master computer device, and a hash signature to the slave computer device.

12. The operation method according to claim 11, wherein the step of performing the key exchange further comprises:
performing identity authentication of the master computer device according to the host public key of the master computer device through the slave computer device;
obtaining shared secret data according to the host public key through the slave computer device, and obtaining hash data according to the hash signature; and
generating a symmetric key for a data channel between the master computer device and the slave computer device and the session identifier according to the shared secret data and the hash data through the slave computer device.

13. The operation method according to claim 12, wherein the step of signing the session identifier comprises:
signing the session identifier according to a private key through the slave computer device.

14. The operation method according to claim 12, further comprising:
copying the public key of the key data to an authorized public key list of the master computer device in advance through the slave computer device; and
determining whether to allow identity authentication according to the authorized public key list through the master computer device.

15. The operation method according to claim 14, wherein the step of authenticating whether the session identifier is correct comprises:
authenticating whether the session identifier is correct according to the public key of the slave computer device through the master computer device to establish the data channel for use during a process of training the large model.
